(19) United States
(12) Patent Application Publication
(10) Pub. No.: US 2010/0243067 A1
(43) Pub. Date: Sep. 30, 2010

(54) OPERATING METHOD FOR A HYDRAULIC MACHINE

(76) Inventors: Uwe Bernhard Pascal Stein, Edinburgh (GB); Niall James Caldwell, Edinburgh (GB); William Hugh Salvin Rampen, Edinburgh (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/161,457

(22) PCT Filed: Feb. 2, 2007
(86) PCT No.: PCT/GB2007/000367

§ 371 Date: Jul. 18, 2008

(30) Foreign Application Priority Data
Feb. 2, 2006 (GB) 0602111.7

(51) Int. Cl. F16K 21/04

(52) U.S. Cl. 137/14; 137/565.13

(57) ABSTRACT

A hydraulic machine has at least one working chamber (11) of cyclically changing volume, and low- and high-pressure valve means (15, 13) to control the connection of the or each chamber to low- and high-pressure lines (16, 14) respectively. A method of operating the machine includes holding the low-pressure valve means (15) closed during at least an entire cycle of the chamber (11), starting at minimum chamber volume, such that gas dissolved in liquid in the chamber is released therefrom during an expansion of the chamber volume and re-dissolved during a reduction thereof.

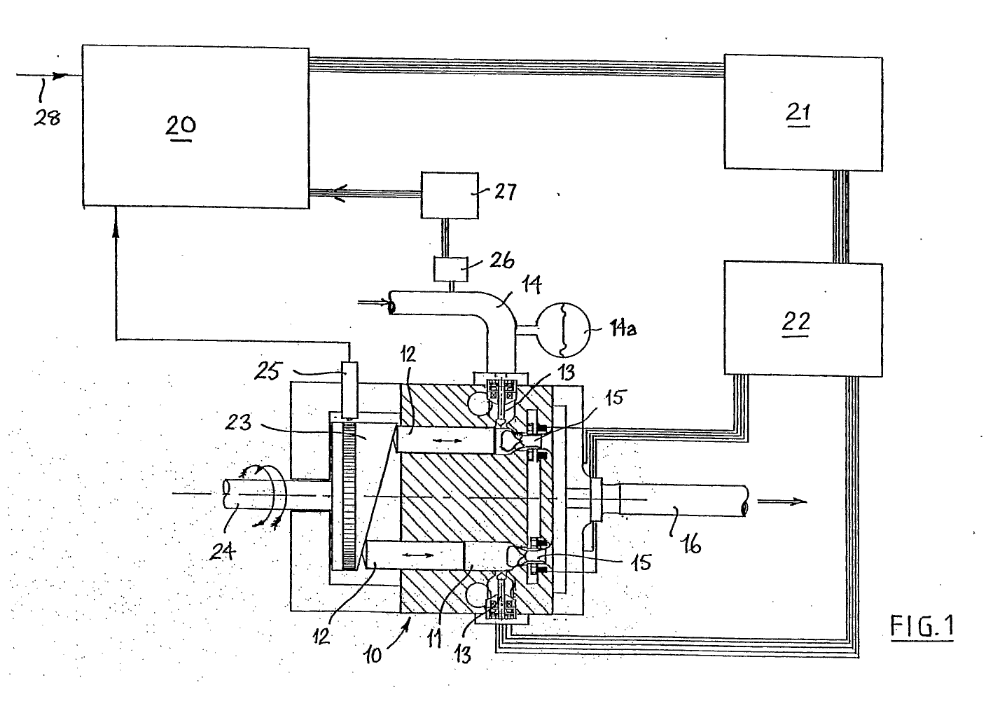

### BACKGROUND TO THE INVENTION

This invention relates to a hydraulic machine, i.e. a motor or pump, having at least one working chamber of cyclically changing volume and valve means to control the connection of the or each chamber to low- and high-pressure manifolds. The invention also relates to a method of operating the machine.

The invention has particular reference to machines where the at least one working chamber comprises a cylinder in which a piston is arranged to reciprocate, but its use with at least one chamber delimited by a flexible diaphragm or a rotary piston is not ruled out.

With most hydraulic machines the fluid chambers undergo cyclical variations in volume following a sinusoidal function. It is known from EP-A-0361927 that a chamber can be left to idle by holding an electromagnetically actuated valve, between the working chamber and the low-pressure source, in the open condition. Thus the output is varied through the through the action of first filling each working chamber with liquid, then deciding whether to reject the liquid back to the low-pressure source or to pump it at pressure to the output manifold. Pumping the liquid back to the low-pressure source means that a very small amount of power needs to be expended, during the time that a working chamber is idle, whilst still allowing the working chambers to become productive with a minimum latency period.

It has become common practice to regulate the flow of piston pumps by closing the intake means part way through the stroke such that the entrained air in the liquid expands and forms bubbles in the liquid during the closed expansion, which occurs below atmospheric pressure. On compression, this volume of air is first compressed before the liquid component of the cylinder reaches the pressure required to open the face-seating non-return valve connected to the high-pressure manifold. It is only once pressure and consequently density of the liquid in the working chamber has increased sufficiently and the valve has opened that delivery to the high-pressure manifold can commence. If the piston has significant velocity when the gas bubble volume nears zero, then the rapid pressure rise, that accompanies this change of compliance, creates an impulsive rise in stress throughout the machine, which results in both audible and fluid-borne noise.

### SUMMARY OF THE INVENTION

The invention seeks to provide an alternative method of controlling the output of a hydraulic machine by means of idle strokes, not experiencing the “breathing loss” associated with pumping the liquid back to the low-pressure source.

The invention provides a method of operating a hydraulic machine having at least one working chamber of cyclically changing volume, and low- and high-pressure valve means to control the connection of the or each chamber to low- and high-pressure lines respectively, the method including holding the low-pressure valve means closed during at least an entire cycle of the chamber, starting at minimum chamber volume, such that gas dissolved in liquid in the chamber is released therefrom during an expansion of the chamber volume and re-dissolved during a reduction thereof.

The liquid typically comprises oil and the gas typically comprises air. It is thus possible to control the displacement of the pump described in EP-A-0361927 by means of air release idle strokes rather than the full flow ones described therein.

To initiate an idle stroke in this mode, the controller must ensure that the induction valve is closed at top-dead-centre, where the chamber comprises a cylinder with a reciprocating piston. The low-pressure valve is then maintained in a closed state throughout the subsequent revolution of the crankshaft, or cycle of the working volume, such that an air release bubble forms during the expansion and closes again upon the compression stroke. The next opportunity to change the state of the working chamber comes at the following minimum volume or top-dead-centre position, when the valve means can be released to open so that the chamber can fill with liquid during a subsequent intake part of the cycle. The low-pressure valve means may comprise an electromagnetically-operated valve, which may be activated, first at full current, to pull the valve into the closed position, the current then being modulated to hold it there.

The invention also provides a hydraulic machine having at least one working chamber of cyclically changing volume, low- and high-pressure valve means to control the connection of the or each chamber to low- and high-pressure lines respectively, and control means for holding the low-pressure valve means closed during at least an entire cycle of the chamber, starting at minimum chamber volume, such that gas dissolved in liquid in the chamber is released therefrom during an expansion of the chamber volume and re-dissolved during a reduction thereof.

The machine may essentially be the same as that of EP-A-0361927 but with a differently-configured control means.

### BRIEF DESCRIPTION OF THE DRAWING

A particular embodiment of the invention will now be described in more detail, by way of example only, and with reference to the accompanying drawing, the single FIGURE of which schematically shows a hydraulic machine according to the invention.

### DETAILED DESCRIPTION OF PARTICULAR EMBODIMENT

A multi-piston hydraulic machine according to the invention is shown in schematic section in the drawing. In the side wall of each cylinder 11 is a high-pressure poppet valve 13 communicating with a high-pressure manifold 14 and in the end wall of each cylinder is a low-pressure poppet valve 15 communicating with a low-pressure manifold 16. The poppet valves 13 and 15 are active electromagnetic valves controlled electrically by a microprocessor controller 20 feeding control signals, via optoisolators 21, to valve-driving semiconductors 22. Note that valve 15 needs to be actively controlled but valve 13 is optionally a passive device

In a motoring mode, pistons 12 act on a drive cam 23 fast to an output shaft 24 and in a pumping mode the pistons 12 are driven by the cam 23, the position of the cam 23 being sensed by position sensing means such as an encoder 25.

The controller 20 receives inputs from the encoder 25, a pressure transducer 26 (via an analogue to digital converter 27) and via a line 28 to which a desired output speed demand signal can be applied.

The poppet valves 13, 15 seal the respective cylinders 11 from the respective manifolds 14, 16 by engagement of an annular valve part with an annular valve seat, a solenoid being provided to magnetically move each said valve part relative to its seat by reacting with ferromagnetic material on the said poppet valve, each said poppet valve having a stem and an enlarged head, the annular valve part being provided on the head and the ferromagnetic material being provided on the stem.

When an air-release idling stroke is required, the controller operates to close one of the low-pressure valves 15 by top-dead centre position of the associated piston, the associated high-pressure valve 13 also being closed at this position. The valves are maintained closed through an entire cycle of the cylinder, during which air is drawn out of the fluid in the cylinder during the expansion stroke and re-dissolves during the compression stroke.

The air release disabling technique gives several benefits. Firstly, the breathing loss through the valve is eliminated on an idle stroke. This equates to saving a substantial amount of power and cooling load on a large machine. Secondly, the intake valve is not subjected to high flow rates on the discharge portion of the idle stroke which would tend to unseat it from the valve latch if the oil was very cold and viscous. Thirdly, the valves can be sized for active strokes rather than for minimizing power dissipation during idle ones.

In cold operation, the air-release method of the invention can be used to control displacement primarily to avoid the de-latching issue created by attempting to pump very viscous oil through the low-pressure valve in the reverse direction.

It has been found that heat generated by the fact that the air release bubble takes a finite time to be compressed does not damage the working fluid over time. The air bubbles are properly absorbed into the liquid during the pressurised portion of the cycle, and do not generate foam when the liquid is returned to the low-pressure line.

In WO2004/025122 we described five modes of operating a fluid-working machine, namely full stroke pumping, part stroke pumping, full stroke motoring, part stroke motoring, and idling. The invention provides a sixth mode, effectively one to be used to hibernate a cylinder to reduce its parasitic loss.

It can be used in conjunction with the other modes and would be selected if the output of the cylinder is not foreseen to be needed within the next revolution or two—a period of known part-load operation. It can also be used if the machine is going into overspeed, since the closed intake valves cannot be pushed closed by high-velocity fluid as they would in a normal idle stroke situation. Overspeed is defined by a combination of shaft speed and fluid viscosity—if the fluid is very cold it is possible to lose control of idling cylinders at much lower shaft speeds.

All forms of the verb “to comprise” used in this specification should be understood as forms of the verbs “to consist of” and/or “to include”.

1. A method of operating a hydraulic machine having at least one working chamber of cyclically changing volume, and low- and high-pressure valves to control the connection of the or each chamber to low- and high-pressure lines respectively, the method including holding the low-pressure valve means closed during at least an entire cycle of the chamber, starting at minimum chamber volume, such that gas dissolved in liquid in the chamber is released therefrom during an expansion of the chamber volume and re-dissolved during a reduction thereof.

2. A method according to claim 1, wherein the liquid comprises oil.

3. A method according to claim 1, wherein the gas comprises air.

4. A method according to claim 1, wherein the low-pressure valve is released to open at a following minimum chamber volume position.

5. A method according to claim 1, wherein the low-pressure valve comprises an electromagnetically-operated valve.

6. A method according to claim 5, wherein the valve is activated, first at full current, to pull the valve into the closed position, the current then being modulated to hold it there.

7. A hydraulic machine having at least one working chamber of cyclically changing volume, low- and high-pressure valves to control the connection of the or each chamber to low- and high-pressure lines respectively, and a controller for holding the low-pressure valve closed during at least an entire cycle of the chamber, starting at minimum chamber volume, such that gas dissolved in liquid in the chamber is released therefrom during an expansion of the chamber volume and re-dissolved during a reduction thereof.

8. A machine according to claim 7, wherein the controller is arranged to release the low-pressure valve means to open at a following minimum chamber volume position.

9. A machine according to claim 7, wherein the low-pressure valve comprises an electromagnetically-operated valve.

10. A machine according to claim 7, having six selectable modes of operation, namely full stroke pumping, part stroke pumping, full stroke motoring, part stroke motoring, idling, and a hibernation mode in which the low-pressure valve is held closed during at least an entire cycle of the chamber.
